(19) United States
(12) Patent Application Publication
(10) Pub. No.: US 2014/0317158 A1
(43) Pub. Date: Oct. 23, 2014

(54) FILE STORAGE DEVICE AND METHOD FOR MANAGING FILE SYSTEM THEREOF

(71) Applicants: Fu Tai Hua Industry (Shenzhen) Co., Ltd., Shenzhen (CN); HON HAI PRECISION INDUSTRY CO., LTD., New Taipei (TW)

(72) Inventors: LING-JUAN JIANG, Shenzhen (CN); CHIH-SAN CHIANG, New Taipei (TW); HUA-DONG CHENG, Shenzhen (CN); HAI-SEN LIANG, Shenzhen (CN); HAI-JUN MAO, Shenzhen (CN)

(73) Assignees: HON HAI PRECISION INDUSTRY CO., LTD., New Taipei (TW); Fu Tai Hua Industry (Shenzhen) Co., Ltd., Shenzhen (CN)

(21) Appl. No.: 14/254,896

(22) Filed: Apr. 17, 2014

(30) Foreign Application Priority Data
Apr. 17, 2013 (CN) 2013101326032

(51) Int. Cl. G06F 17/30

(52) U.S. Cl. CPC G06F 17/30091
USPC 707/822

(57) ABSTRACT

A method for managing a file system includes traversing the file system to create a directory tree corresponding to the file system. The directory tree comprises at least one parent node and at least one child node. Each of the at least one parent nodes of the directory tree corresponds to a folder of the file system. Each of the at least one child nodes of the directory tree corresponds to a file of the file system. All the nodes of the directory tree are monitored to determine whether the directory tree changes. Changed information of the file system is extracted when the directory tree changes. A file storage device using the method is also provided by the present disclosure.

### FIELD

The present disclosure relates to data management, and particularly to a file storage device and a method for managing a file system thereof.

### BACKGROUND

In a computing device, a file system is used to control how data is stored and includes a number of files and folders. Once a file or a folder has been changed in a file system, the file system needs to be traversed twice to find which file or folder has been changed.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a diagrammatic view of a file system stored in a storage unit.

FIG. 2 is a diagrammatic view of a directory tree corresponding to the file system of FIG. 1.

FIG. 3 is a block diagram of an embodiment of a file storage device.

FIG. 4 is a flowchart of an embodiment of a management method of a file system applied to the file storage device of FIG. 3.

### DETAILED DESCRIPTION

Before the detailed description of the present disclosure, there is a brief description of a storage mode of files or folders contained in a file system that is related to at least one embodiment of the present disclosure.

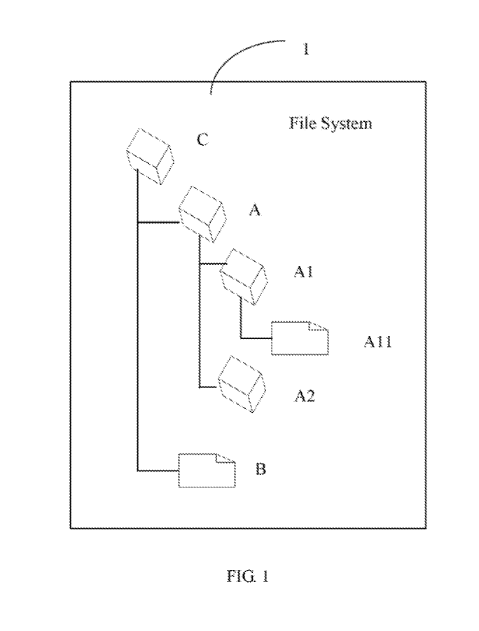

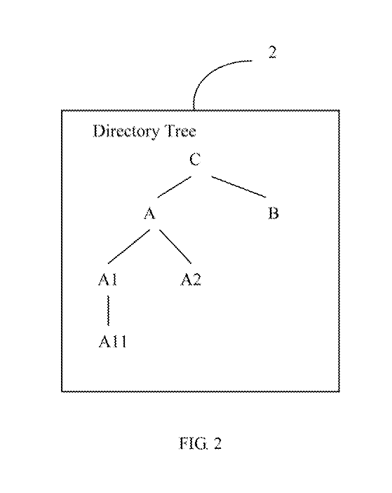

FIG. 1 illustrates an example of a file system (hereinafter “file system 1”) stored in a storage unit, such as the C drive of a computer. FIG. 2 illustrates a directory tree corresponding to the file system 1 of FIG. 1. The file system 1 includes a first level folder C. The folder C includes a child folder A and a file B. The folder A further includes two child folders A1 and A2, and the child folder A1 includes a file A11. The file system 1 further includes access paths to each folder and each file in the file system 1. For example, the access path to the file A11 is C:\A:\A1:\A11, and the access path to the folder A1 is C:\A:\A1. The information about the files and folders, and access paths to the files and folders of the file system 1, are organized to form the directory tree 2 as illustrated in FIG. 2. A node A of the directory tree 2 corresponds to the folder A of the file system 1. A node B of the directory tree 2 corresponds to the folder B of the file system 1. A node A1 of the directory tree 2 corresponds to the folder A1 of the file system 1. A node A2 of the directory tree 2 corresponds to the folder A2 of the file system 1. A node A11 of the directory tree 2 corresponds to the file A11 of the file system 1. The information of node A includes an access path (C:\A) to folder A and the information of the node A1, A2. The information of the node A1 includes an access path (C:\A:\A1) to folder A1, and further includes information of the node A11. The information of the node A11 includes an access path (C:\A:\A1:\A11) and the data in the file A11. The information of the other nodes is acquired accordingly.

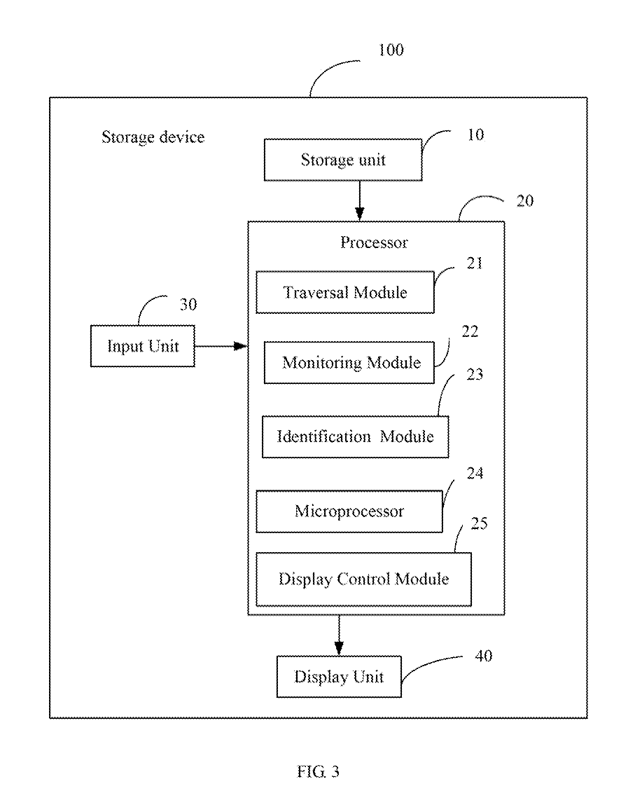

FIG. 3 illustrates an embodiment of a file storage device 100. The file storage device 100 includes a storage unit 10, a processor 20, an input unit 30, and a display unit 40.

The storage unit 10 stores a file system, such as the file system 1 shown in FIG. 1. The file system includes at least one file and/or at least one folder. The file can be a text file, a picture, a video file, an audio file, an application program, or the like.

The processor 20 includes a traversal module 21, a monitoring module 22, a identification module 23, and a microprocessor 24.

The traversal module 21 traverses the file system in the storage unit 10 and creates a directory tree corresponding to the file system according to the traversal result. In at least one embodiment, the traversal module 21 traverses the file system in level-order. Each of the parent nodes of the directory tree corresponds to a folder of the file system, and each of the child nodes of the directory tree corresponds to a file of the file system. In one embodiment, the information of each of the nodes includes at least a node mark, an access path to the node, a node type, and node content. When the node is a parent node, the node content of the parent node includes information of all files and folders directly contained in the parent node. When the node is a child node, the content of the child node includes a file size, a file name, a file format, a creation time of the file, a modification time of the file, and data of the file.

In the embodiment, the node mark is a hashed value of the access path to the node and the node content. When the content of a file or the access path to the file is changed, all node marks in the parent nodes and child nodes associated with the file are changed accordingly.

In a first embodiment, the hashed value of a file is a message-digest (MD) algorithm value and is calculated by using a cryptographic hash function of MD based on the access path to the file and the content of the file. In a second embodiment, the hashed value of a file is a security hash algorithm (SHA) value and is calculated by using a cryptographic hash function of SHA based on the access path to the file and the content of the file.

The monitoring module 22 monitors all nodes of the directory tree to determine whether the directory tree changes. In the embodiment, the monitoring module 22 monitors nodes of the directory tree in post-order. The monitoring module 22 further determines which nodes of the directory have been changed.

The identification module 23 identifies the type of the changed node. When the changed node is a parent node, the traversal module 22 traverses the node mark of nodes contained in the changed node in post-order to find the files and/or folders whose content and/or access paths have been changed and contained in the changed parent node.

The microprocessor 24 extracts changed information of the file system. In a second embodiment, the microprocessor 24 creates relationships between the changed information and the changed node, and further updates the directory tree corresponding to the change information and the created relationships. For example, when a new file is added to the file system, the changed information of the file system includes the content of the added file and the access path to the added file. When a file or a folder is transferred from a first folder to a second folder, the changed information of the file system is a new access path to the transferred file.

The processor 20 further includes a display control module 25. The display control module 25 controls the display unit 40 to display the extracted changed information in response to a preview request signal of changed information generated by the input unit 30.

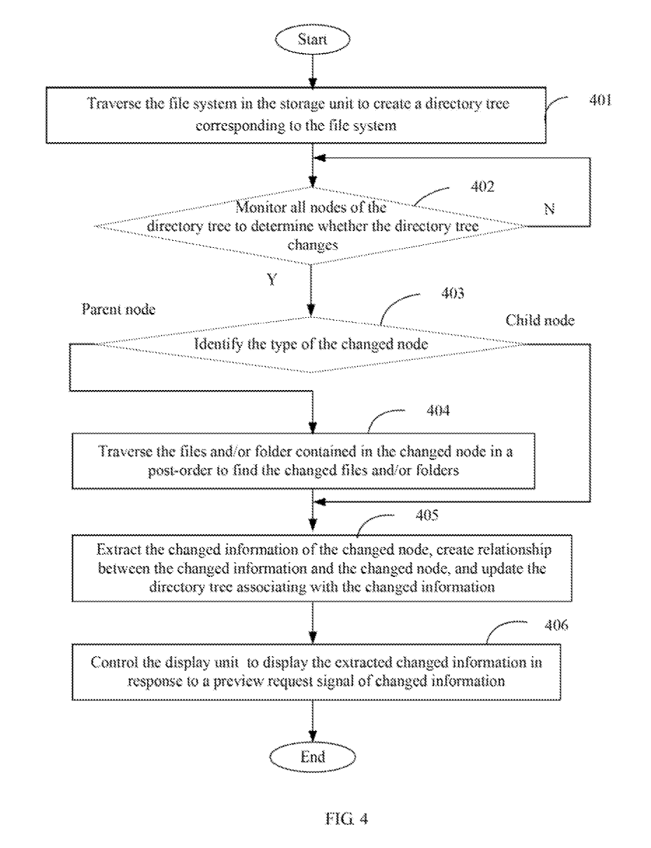

FIG. 4 illustrates a flowchart of an embodiment of a method for managing a file system. The method is applied to the file storage device 100. The method includes steps, each of which is related to the various components of the file storage device 100.

In block 401, the traversal module traverses the file system in the storage unit to create a directory tree corresponding to the file system. The parent node of the directory tree corresponds to a folder of the file system. The child node of the directory tree corresponds to a file of the file system.

In the embodiment, the traversal module traverses the file system in level-order.

In block 402, the monitoring module monitors all nodes of the directory tree to determine whether the directory tree changes. If the directory tree changes, the process goes to block 403. If the directory tree does not change, the process goes back to block 402.

In at least one embodiment, the monitoring module monitors the nodes of the directory tree in post-order. The monitoring module further determines which nodes of the directory tree have been changed.

In block 403, the identification module identifies the type of the changed node. If the changed node is a parent node, the process goes to block 404. If the changed node is a child node, the process goes to block 405.

In block 404, the traversal module traverses the files and/or folders contained in the changed node in post-order to find the changed files and/or folders whose content and/or access paths have been changed and contained in the changed parent node.

In block 405, the microprocessor extracts the changed information of the changed node. In an alternative embodiment, the microprocessor creates relationships between the changed information and the changed node, and further updates the directory tree according to the changed information and the created relationships.

In block 406, the display control module controls the display unit to display the extracted changed information in response to a preview request signal of changed information generated by the input unit.

Although the present disclosure has been described in considerable detail with reference to certain preferred embodiments thereof, the disclosure is not for limiting the scope of the disclosure. Persons having ordinary skill in the art may make various modifications and changes without departing from the scope and spirit of the disclosure. Therefore, the scope of the appended claims should not be limited to the description of the preferred embodiments described above.

What is claimed is:

1. A file storage device, comprising:
a storage unit storing a file system, the file system comprising at least one file or at least one folder; and
a processor comprising:
a traversal module configured to traverse the file system to create a directory tree corresponding to the file system, the directory tree comprising at least one parent node and at least one child node, each of the at least one parent node of the directory tree corresponding to a folder of the file system, each of the at least one child node of the directory tree corresponding to a file of the file system;
a monitoring unit configured to monitor all the nodes of the directory tree to determine whether the directory tree changes;
a microprocessor configured to extract changed information of the file system when the directory tree changes.

2. The file storage device as described in claim 1, wherein the traversal module traverses the file system in level-order.

3. The file storage device as described in claim 2, wherein each of the nodes of the directory tree comprises elements consisting of: a node mark, an access path to the node, a node type and node content.

4. The file storage device as described in claim 3, wherein the node mark is a hashed value of the access path to the node and the node content contained in the node.

5. The file storage device as described in claim 4, wherein the monitoring module further determines which nodes of the directory tree have been changed.

6. The file storage device as described in claim 5, wherein the processor also comprises an identification module configured to identify the type of each of the changed nodes.

7. The file storage device as described in claim 6, wherein when the node type of one of the changed nodes is a parent node, the traversal module traverses the node mark of the nodes contained in the changed node in post-order to find the changed files or folders contained in the changed parent node.

8. The file storage device as described in claim 5, wherein the microprocessor also creates relationships between the changed information and the changed nodes.

9. The file storage device as described in claim 8, wherein the microprocessor updates the directory tree according to the changed information.

10. The file storage device as described in claim 1, further comprising a display unit, wherein the processor comprises a display control module configured to control the display unit to display the changed information of the file system.

11. A method for managing a file system, the file system stored in a storage device and comprising at least one file or at least one folder, the method comprising:
traversing the file system to create a directory tree associating with the file system, the directory tree comprising at least one parent nodes and at least one child nodes, each of the at least one parent node of the directory tree corresponding to a folder of the file system, each of the at least one child nodes of the directory tree corresponding to a file of the file system;
monitoring all the nodes of the directory tree to determine whether the directory tree changes;
extracting changed information of the file system when the directory tree changes.

12. The management method as described in claim 11, wherein traversing the file system in level-order.

13. The management method as described in claim 12, wherein the method further comprises:
determining which nodes of the directory tree have been changed;
identifying the node type of each of the changed nodes.

14. The management method as described in claim 13, wherein the method further comprises:
traversing the files and folders contained in the changed parent node in post-order to find the changed files or folders contained in the changed parent node when a change node is a parent node.

15. The management method as described in claim 13, wherein the method further comprises creating relationships between the changed information and the changed node.

16. The management method as described in claim 15, wherein the method further comprises updating the directory tree according to the changed information and the created relationships.

17. The management method as described in claim 11, wherein the method further comprises displaying the changed information of the file system.
